(19) United States
(12) Patent Application Publication
(10) Pub. No.: US 2025/0360962 A1
(43) Pub. Date: Nov. 27, 2025

(54) MOBILITY VEHICLE

(71) Applicants: HYUNDAI MOTOR COMPANY, Seoul (KR); KIA CORPORATION, Seoul (KR)

(72) Inventors: Jae Hyuk Choi, Hwaseong-si (KR); Geun Sang Yu, Hwaseong-si (KR); Jea Kyoo An, Hwaseong-si (KR)

(73) Assignees: HYUNDAI MOTOR COMPANY, Seoul (KR); KIA CORPORATION, Seoul (KR)

(21) Appl. No.: 18/898,177

(22) Filed: Sep. 26, 2024

(30) Foreign Application Priority Data
May 22, 2024 (KR) 10-2024-0066621

(51) Int. Cl. B62D 7/15; B62D 3/12; B62D 5/04

(52) U.S. Cl. CPC B62D 7/1518; B62D 3/126; B62D 5/0457

(57) ABSTRACT

A mobility vehicle includes a body part, a movement part, and at least one variable frame. The movement part includes a wheel configured to move the body part, and a steering region configured to rotate the wheel about a steering rotation axis relative to the body part and steer the wheel. The at least one variable frame is configured to connect the body part and the movement part, move relative to the body part in a guide direction intersecting the steering rotation axis, and change a spacing distance between one region of the body part and the movement part.

### CROSS-REFERENCE TO RELATED APPLICATION

This application claims priority to and the benefit of Korean Patent Application No. 10-2024-0066621, filed in the Korean Intellectual Property Office on May 22, 2024, the entire contents of which are incorporated herein by reference.

### TECHNICAL FIELD

The present disclosure relates to a mobility vehicle.

### BACKGROUND ART

Recently, plug-and-drive (PnD) module-based mobility vehicles have been actively developed. The mobility vehicle is equipped with a body part capable of supporting an object, a plurality of wheels configured to allow the body part to travel, and a steering system configured to steer the plurality of wheels.

In the related art, the mobility vehicle has been manufactured with positions of the wheels fixed relative to the body part. In case that the positions of the wheels relative to the body part are fixed, there is a problem in that intervals between the wheels and the body part cannot be adjusted.

For example, if the mobility vehicle is manufactured with relatively large gap between the wheels and the body part, it may encounter difficulty when entering narrow spaces, such as an elevator or hallway. If the mobility vehicle is manufactured with relatively small intervals between the wheels and the body part, there is a problem in that a risk of rollover accident of the mobility vehicle traveling at a high speed increases.

The statements in this section merely provide background information related to the present disclosure and may not constitute prior art.

### SUMMARY

The present disclosure provides a mobility vehicle capable of adjusting an interval between a wheel and a body part.

In order to achieve the above-mentioned object, one aspect of the present disclosure provides a mobility vehicle including: a body part; a movement part including a wheel configured to move the body part. The movement part further includes a steering region configured to rotate the wheel about a steering rotation axis relative to the body part and steer the wheel. The mobility vehicle also includes: at least one variable frame configured to connect the body part and the movement part, move relative to the body part in a guide direction intersecting the steering rotation axis, and change a spacing distance between one region of the body part and the movement part.

In an embodiment, the movement part may be fixed to the at least one variable frame, and the at least one variable frame may be connected to the body part and configured to be movable relative to the body part.

In an embodiment, the mobility vehicle may further include: a guide fixed to the body part, extending in the guide direction, and configured to guide a movement of the at least one variable frame in the guide direction.

In an embodiment, the at least one variable frame may be provided as a plurality of variable frames. Each of the plurality of variable frames is configured to be placed in a first state, in which each variable frame is maximally moved in a first guide direction relative to the body part, The first guide direction is a direction in which the wheel moves toward the body in the guide direction. Two variable frames, which are oriented in directions intersecting each other among the plurality of variable frames placed in the first state, may be disposed to overlap each other when one side of the mobility vehicle based on a direction of the steering rotation axis is viewed in parallel with the steering rotation axis.

In an embodiment, the plurality of variable frames may include a first variable frame and a second variable frame oriented in the directions intersecting each other, and the first variable frame and the second variable frame may be disposed to be spaced apart from each other in the direction of the steering rotation axis.

In an embodiment, the first variable frame may be provided as a plurality of first variable frames. The plurality of first variable frames may include a first-first variable frame; and a first-second variable frame oriented in parallel with the first-first variable frame. At least a part of the first-first variable frame and at least a part of the first-second variable frame may be disposed to face each other in a direction perpendicular to the direction of the steering rotation axis.

In an embodiment, the mobility vehicle may further include a drive part configured to move the at least one variable frame, and the drive part includes a rotation region configured to engage with the at least one variable frame and rotate about a drive rotation axis. The at least one variable frame is configured to be rectilinearly moved in the guide direction by a rotation of the rotation region.

In an embodiment, the at least one variable frame may be provided in the form of a rack gear extending in the guide direction, and the rotation region may be provided in the form of a pinion gear engaging with the at least one variable frame.

In an embodiment, the steering rotation axis may extend in an upward/downward direction, and a lower end of the body part may be disposed above an upper end of the wheel.

In an embodiment, the mobility vehicle may further include: a controller configured to control the movement part. When an adjustment signal, which is a signal indicating that a size of the mobility vehicle is required to be adjusted, is inputted, the controller is configured to control the steering region to steer the wheel in parallel with the guide direction.

In an embodiment, when a contraction signal, which is a signal indicating that a size of the mobility vehicle is required to be decreased, is inputted, the controller may control the wheel so that the wheel becomes close to one region of the body part. When an expansion signal, which is a signal indicating that a size of the mobility vehicle is required to be increased, is inputted, the controller may control the wheel so that the wheel becomes distant from one region of the body part.

In an embodiment, the wheel and the at least one variable frame may be respectively provided as a plurality of wheels and a plurality of variable frames, and when the contraction signal or the expansion signal is received, the controller may control the plurality of wheels so that all of the plurality of variable frames are moved at the same speed.

In an embodiment, the mobility vehicle may further include a drive part configured to move the at least one variable frame. When a contraction signal, which is a signal indicating that a size of the mobility vehicle is required to be decreased, is inputted, the controller is configured to control the drive part so that the wheel becomes close to one region of the body part, and when an expansion signal, which is a signal indicating that a size of the mobility vehicle is required to be increased, is inputted, the controller is configured to control the drive part so that the wheel becomes distant from one region of the body part.

In an embodiment, the at least one variable frame may be provided as a plurality of variable frames, and when the contraction signal or the expansion signal is received, the controller may control the drive part so that all of the plurality of variable frames are moved at the same speed.

In an embodiment, the mobility vehicle may further include: a detection part configured to detect a motion of an object in a peripheral region of the mobility vehicle, and the wheel and the at least one variable frame are respectively provided as a plurality of wheels and a plurality of variable frames. When the detection part detects a motion of the object in the peripheral region, the controller receives an avoidance signal, which is a signal indicating that the mobility vehicle is required to avoid the object, from the detection part, and when a wheel, which is positioned to be closest to the object among the plurality of wheels, is a short-distance wheel, and a wheel, which is positioned to be farthest from the short-distance wheel, is a long-distance wheel, the controller, which receives the avoidance signal, controls the movement parts so that a speed of the short-distance wheel is higher than a speed of the long-distance wheel.

In an embodiment, the controller, which receives the avoidance signal, may control the movement part to brake the long-distance wheel.

In an embodiment, the controller, which receives the avoidance signal, may control the steering regions so that the long-distance wheel is oriented in a direction intersecting the short-distance wheel.

In an embodiment, the plurality of wheels may include a first wheel, a second wheel, and a third wheel, which are sequentially disposed to be spaced apart from one another in a peripheral direction of the body part. When the short-distance wheel and the long-distance wheel are respectively the first wheel and the third wheel, the controller may control the plurality of wheels so that a speed of the first wheel is higher than a speed of the second wheel.

The mobility vehicle according to the present disclosure may be configured to adjust the gap between the wheel and the body part, thereby flexibly coping with various situations by adjusting the gap between the wheel and the body part.

### BRIEF DESCRIPTION OF THE DRAWINGS

FIG. 1 is a first perspective view of a mobility vehicle according to a first embodiment of the present disclosure.

FIG. 2 is a second perspective view of the mobility vehicle according to the first embodiment of the present disclosure.

FIG. 3 is a top plan view of the mobility vehicle according to the first embodiment of the present disclosure.

FIG. 4 is a view illustrating a state in which a variable frame of the mobility vehicle in FIG. 3 is moved.

FIG. 5 is a side view of the mobility vehicle according to the first embodiment of the present disclosure.

FIG. 6 is a side view of a mobility vehicle according to a modified example of the first embodiment of the present disclosure.

FIG. 7 is a top plan view of a mobility vehicle according to a second embodiment of the present disclosure.

FIG. 8 is a top plan view of a mobility vehicle according to a third embodiment of the present disclosure.

FIG. 9 is a top plan view of a mobility vehicle according to a fourth embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the illustrative drawings. In giving reference numerals to constituent elements of the respective drawings, it should be noted that the same constituent elements are designated by the same reference numerals, if possible, even though the constituent elements are illustrated in different drawings. Further, in the following description of the embodiments of the present disclosure, a detailed description of related publicly-known configurations or functions have been omitted when it is determined that the detailed description obscures the understanding of the embodiments of the present disclosure.

Hereinafter, a mobility vehicle 1 according to the present disclosure is described with reference to the drawings.

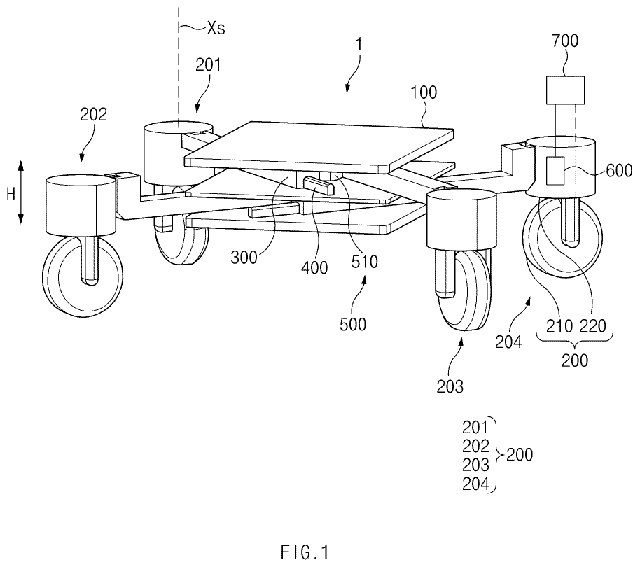

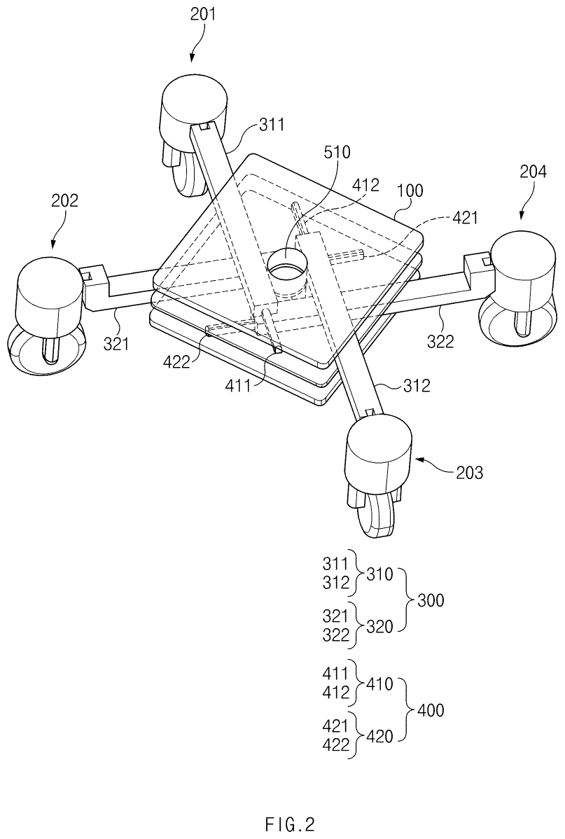

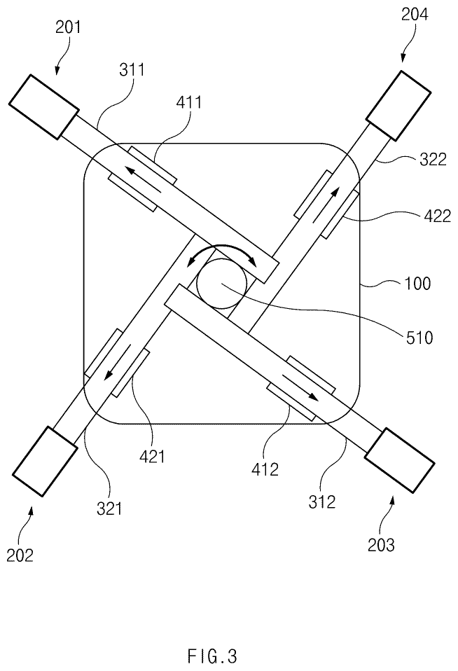

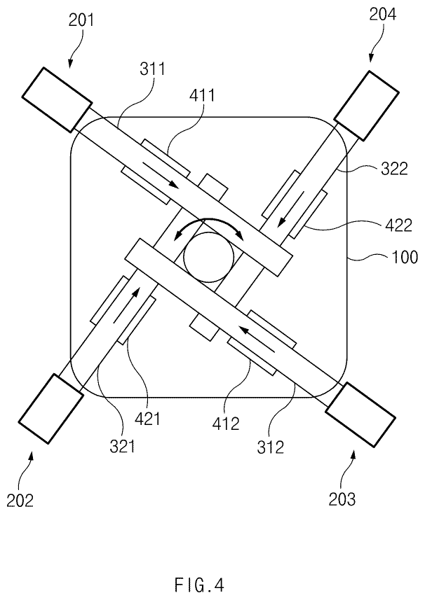

FIG. 1 is a first perspective view of a mobility vehicle according to a first embodiment of the present disclosure, FIG. 2 is a second perspective view of the mobility vehicle according to the first embodiment of the present disclosure, FIG. 3 is a top plan view of the mobility vehicle according to the first embodiment of the present disclosure, and FIG. 4 is a view illustrating a state in which a variable frame of the mobility vehicle in FIG. 3 is moved.

With reference to FIGS. 1 to 4, the mobility vehicle 1 may travel on a ground surface. The mobility vehicle 1 may move an object, which is required to be moved between locations, to a targeted position. The mobility vehicle 1 may be referred to as a movable body 1. The mobility vehicle 1 may include a body part 100, movement parts 200, variable frames 300, guides 400, a drive part 500, a detection part 600, and a controller 700.

The body part 100 may provide a space for seating an object that is required to be moved. The body part 100 may be moved by the movement part 200. The body part 100 may include a plurality of plates. The plurality of plates may be arranged to be spaced apart from one another in an upward/downward direction “H”. For example, the variable frame 300 may be disposed between two plates adjacent to each other among the plurality of plates.

The movement part 200 may move the body part 100 relative to the ground surface. The movement part 200 may be fixed to the variable frame 300. In addition, the movement part 200 may be controlled by the controller 700. The movement part 200 may include a wheel 210 and a steering region 220.

The wheel 210 may be disposed below the steering region 220. An upper end of the wheel 210 may be disposed below a lower end of the body part 100. As described above, the body part 100 may be disposed above the wheel 210, which may avoid or prevent the wheel 210 and the body part 100 from interfering with each other while the wheel 210 moves relative to the body part 100.

The steering region 220 may steer the wheel 210. The steering region 220 may rotate the wheel 210 about a steering rotation axis Xs relative to the body part 100. For example, the steering rotation axis Xs may be parallel to the upward/downward direction H. The steering region 220 and the wheel 210 may be connected to each other and configured to be rotatable relative to each other. In addition, the steering region 220 may be fixed to one end of the variable frame 300.

In one embodiment, the movement parts 200 may be provided as a plurality of movement parts 200. The plurality of movement parts 200 may include a first movement part 201, a second movement part 202, a third movement part 203, and a fourth movement part 204. The first movement part 201, the second movement part 202, the third movement part 203, and the fourth movement part 204 may be sequentially disposed in a peripheral direction of the body part 100. In addition, the wheels, which are respectively provided in the first movement part 201, the second movement part 202, the third movement part 203, and the fourth movement part 204, may be referred to as a first wheel 211, a second wheel 212, a third wheel 213, and a fourth wheel 214. In addition, the steering regions 220, which are respectively provided in the first movement part 201, the second movement part 202, the third movement part 203, and the fourth movement part 204, may be referred to as a first steering region, a second steering region, a third steering region, and a fourth steering region.

The variable frame 300 may change a spacing distance between one region of the body part 100 and the movement part 200. The variable frame 300 may move relative to the body part 100 in a guide direction. The variable frame 300 may connect the body part 100 and the movement part 200.

For example, the movement part 200 may be fixed to the variable frame 300, and the variable frame 300 may be movably connected to the body part 100. As a more detailed example, the variable frame 300 may be movably connected to the guide 400 fixed to the body part 100.

The variable frames 300 may be provided as a plurality of variable frames 300. The plurality of variable frames 300 may be disposed to be spaced apart from one another. The plurality of variable frames 300 may each be placed in a first state in which the variable frame 300 is maximally moved in a first guide direction relative to the body part 100. The first guide direction may be defined as a direction, i.e., the guide direction in which the wheel 210 moves toward the body part 100.

With reference to FIG. 4, two variable frames, which are oriented in directions intersecting each other among the plurality of variable frames 300 placed in the first state, may be disposed to overlap each other when an upper portion of the mobility vehicle 1 is viewed in parallel with the upward/downward direction H. The plurality of variable frames 300 may include first variable frames 310 and second variable frames 320.

The first variable frame 310 and the second variable frame 320 may be spaced apart from each other in the upward/downward direction H. For example, the first variable frame 310 may be disposed above the second variable frame 320. In addition, a direction, in which the first variable frame 310 extends, and a direction, in which the second variable frame 320 extends, may intersect each other. In other words, the first variable frame 310 and the second variable frame 320 may be oriented in the directions intersecting each other.

In addition, the first variable frame 310 and the second variable frame 320 placed in the first state may be disposed to overlap each other when the upper portion of the mobility vehicle 1 is viewed in parallel with the upward/downward direction H. In other words, because the first variable frame 310 and the second variable frame 320 may be disposed to be spaced apart from each other in the upward/downward direction H, the first variable frame 310 and the second variable frame 320 may move relative to the body part 100 without interfering with each other. The first variable frames 310 may be provided as a plurality of first variable frames 310. The plurality of first variable frames 310 may include a first-first variable frame 311 and a first-second variable frame 312.

At least a part of the first-first variable frame 311 and at least a part of the first-second variable frame 312 may be disposed to face each other in a first horizontal direction intersecting the steering rotation axis Xs. For example, the first horizontal direction may be perpendicular to the steering rotation axis Xs and the direction in which the first variable frame 310 extends. For example, the first-first variable frame 311 and the first-second variable frame 312 may be oriented in parallel with each other. The first-first variable frame 311 and the first-second variable frame 312 may have the same shape.

The first movement part 201 may be fixed to the first-first variable frame 311. For example, the first movement part 201 may be configured to move together with the first-first variable frame 311. In addition, the third movement part 203 may be fixed to the first-second variable frame 312. For example, the third movement part 203 may be configured to move together with the first-second variable frame 312.

The first-first variable frame 311 and the first-second variable frame 312 may be configured to move at the same speed relative to the body part 100. For example, a speed of the first movement part 201 relative to the body part 100 may be equal to a speed of the third movement part 203 relative to the body part 100.

In addition, the second variable frames 320 may be provided as a plurality of second variable frames 320. The plurality of second variable frames 320 may include a second-first variable frame 321 and a second-second variable frame 322. At least a part of the second-first variable frame 321 and at least a part of the second-second variable frame 322 may be disposed to face each other in a second horizontal direction intersecting the steering rotation axis Xs. For example, the second horizontal direction may be perpendicular to the first horizontal direction and the steering rotation axis Xs. For example, the second-first variable frame 321 and the second-second variable frame 322 may be oriented in parallel with each other. The second-first variable frame 321 and the second-second variable frame 322 may have the same shape.

The second movement part 202 may be fixed to the second-first variable frame 321. For example, the second movement part 202 may be configured to move together with the second-first variable frame 321. In addition, the fourth movement part 204 may be fixed to the second-second variable frame 322. For example, the fourth movement part 204 may be configured to move together with the second-second variable frame 322.

The second-first variable frame 321 and the second-second variable frame 322 may be configured to move at the same speed relative to the body part 100. For example, a speed of the second movement part 202 relative to the body part 100 may be equal to a speed of the fourth movement part 204 relative to the body part 100.

The guide 400 may guide the movement of the variable frame 300 in the guide direction. For example, the variable frame 300 may slidably engage with the guide 400. The guide 400 may be fixed to the body part 100. The guides 400 may be provided as a plurality of guides 400. The plurality of guides 400 may include first guides 410 and second guides 420.

The first guide 410 may guide the movement of the first variable frame 310. The first guides 410 may be provided as a plurality of first guides 410. The plurality of first guides 410 may include a first-first guide 411 and a first-second guide 412.

The first-first guide 411 may guide the movement of the first-first variable frame 311. For example, the first-first variable frame 311 may slidably engage with the first-first guide 411. The first-second guide 412 may guide the movement of the first-second variable frame 312. For example, the first-second variable frame 312 may slidably engage with the first-second guide 412.

The second guide 420 may guide the movement of the second variable frame 320. The second guides 420 may be provided as a plurality of second guides 420. The plurality of second guides 420 may include a second-first guide 421 and a second-second guide 422.

The second-first guide 421 may guide the movement of the first-second variable frame 312. For example, the second-first variable frame 321 may slidably engage with the second-first guide 421. The second-second guide 422 may guide the movement of the second-second variable frame 322. For example, the second-second variable frame 322 may slidably engage with the second-second guide 422.

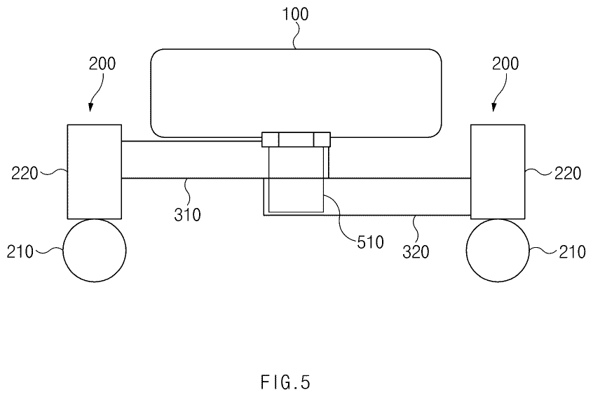

With further reference to FIG. 5, the drive part 500 may provide the variable frame 300 with power for moving the variable frame 300.

FIG. 5 is a side view of the mobility vehicle according to the first embodiment of the present disclosure.

The drive part 500 may be disposed on a central portion of the body part 100. The drive part 500 may include a rotation region 510. The rotation region 510 may rotate about a first rotation axis. The first rotation axis may be defined as an imaginary straight line passing through a center of the rotation region 510 and extending in the upward/downward direction H. The rotation region 510 may have a column shape extending in the upward/downward direction H.

With reference back to FIGS. 3 and 4, the rotation region 510 may be configured to engage with the plurality of variable frames 300. For example, the plurality of variable frames 300 may engage with an outer peripheral surface of the rotation region 510. As a more detailed example, the variable frame 300 may be provided in the form of a rack gear extending in the guide direction, and the rotation region 510 may be provided in the form of a pinion gear engaging with the variable frame 300. In other words, the variable frame 300 may be rectilinearly moved by a rotational motion of the rotation region 510, or the rotation region 510 may be rotated by a rectilinear motion of the variable frame 300.

The detection part 600 may detect changes in the width of a space in a peripheral region of the mobility vehicle 1. For example, the detection part 600 may detect a difference between a width of a space in which the mobility vehicle 1 is currently positioned and a width of a space positioned in a scheduled traveling route. In addition, the detection part 600 may detect a motion of an object in the peripheral region of the mobility vehicle 1. For example, the detection part 600 may include at least one of an infrared sensor, an ultrasonic sensor, or a lidar sensor, which is capable of detecting objects. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The controller 700 may control the wheel 210. When an adjustment signal, which is a signal indicating that a size of the mobility vehicle 1 is required to be adjusted, is inputted, the controller 700 may control the steering region 220 to steer the wheel 210 in parallel with the guide direction. For example, when the adjustment signal is received, the controller 700 may control the steering regions 220 so that the first wheel 211 and the third wheel 213 are oriented in parallel with the second horizontal direction and the second wheel 212 and the fourth wheel 214 are oriented in parallel with the first horizontal direction.

When a contraction signal is inputted to the controller 700, the controller 700 may control the wheel 210 so that the wheel 210 becomes close to one region of the body part 100. The contraction signal may mean a signal indicating that the size of the mobility vehicle 1 is required to be decreased. For example, the contraction signal may be generated by the detection part 600 on the basis of a detection result from the detection part 600. For example, when the detection part 600 detects that the width of the space in the scheduled traveling route becomes smaller than the width of the space in which the mobility vehicle 1 is currently positioned based on the state in which the mobility vehicle 1 is traveling, the detection part 600 may generate the contraction signal, and the generated contraction signal may be inputted to the controller 700.

In addition, when an expansion signal is inputted to the controller 700, the controller 700 may control the wheel 210 so that the wheel 210 becomes distant from one region of the body part 100. The expansion signal may be a signal indicating that the size of the mobility vehicle 1 is required to be increased. For example, the expansion signal may be generated by the detection part 600 on the basis of a detection result from the detection part 600. For example, when the detection part 600 detects that the width of the space in the scheduled traveling route becomes larger than the width of the space in which the mobility vehicle 1 is currently positioned based on the state in which the mobility vehicle 1 is traveling, the detection part 600 may generate the expansion signal, and the generated expansion signal may be inputted to the controller 700.

When the contraction signal or expansion signal is inputted to the controller 700, the controller 700 may control the plurality of wheels 211, 212, 213, and 214 so that all of the plurality of variable frames are moved at the same speed.

In addition, in case that the detection part 600 detects a motion of an object within the peripheral region, the controller 700 may receive an avoidance signal from the detection part. The avoidance signal may be a signal indicating that the mobility vehicle is required to avoid an object. For example, the avoidance signal may be generated by the detection part 600 on the basis of a detection result from the detection part 600.

The controller 700, which receives the avoidance signal, may control the movement parts 200 so that a speed of a short-distance wheel is higher than a speed of a long-distance wheel. The short-distance wheel may mean the wheel positioned to be closest to the object among the plurality of wheels 211, 212, 213, and 214. The long-distance wheel may mean the wheel positioned to be farthest from the object among the plurality of wheels 211, 212, 213, and 214.

When the avoidance signal is inputted to the controller 700, the controller 700 may control the movement part to brake the long-distance wheel. For example, when the avoidance signal is inputted to the controller 700, the controller 700 may control the plurality of wheels so that the short-distance wheel moves toward the long-distance wheel in the guide direction in a state in which the long-distance wheel is stopped in place. For example, when the avoidance signal is inputted to the controller 700, the long-distance wheel may serve as an anchor that supports the mobility vehicle 1 on the ground surface.

When the avoidance signal is inputted to the controller 700, the controller 700 may control the steering regions 220 so that the long-distance wheel is oriented in a direction intersecting (e.g., a direction perpendicular to) the short-distance wheel. As described above, when the avoidance signal is inputted to the controller 700, the long-distance wheel may securely support the mobility vehicle 1 on the ground surface while the short-distance wheel moves.

In addition, in case that the short-distance wheel and the long-distance wheel are respectively the first wheel 211 and the third wheel 213, the controller 700 may control the plurality of wheels 211, 212, 213, and 214 so that a speed of the first wheel 211 is higher than a speed of the second wheel 212 and a speed of the fourth wheel 214. For example, when the avoidance signal is inputted to the controller 700, the controller 700 may control the plurality of wheels so that the first wheel 211 moves at a first speed in the first horizontal direction, the second wheel 212 and the fourth wheel 214 each move at a second speed (a speed lower than the first speed) in the second horizontal direction, and the third wheel 213 is stopped. In addition, for example, the first speed may be twice the second speed.

The controller 700 may be electrically connected to the movement parts 200, the drive part 500, and the detection part 600 and implemented as a process that serves to decode and execute instructions on the basis of inputted information.

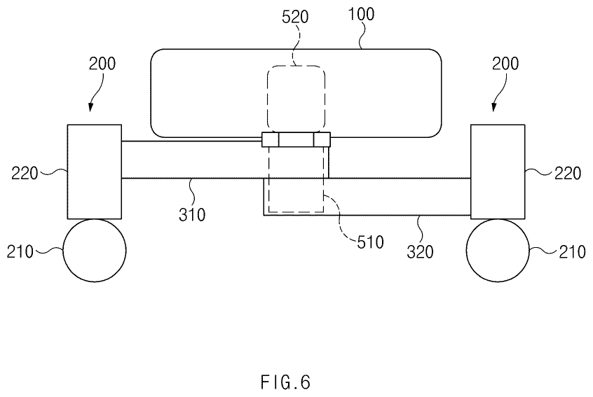

With reference to FIG. 6, the drive part 500 according to a modified example of the first embodiment of the present disclosure may further include a motor 520.

FIG. 6 is a side view of the mobility vehicle according to the modified example of the first embodiment of the present disclosure.

With reference to FIG. 6, the motor 520 may provide the rotation region 510 with rotational power for rotating the rotation region 510. The motor 520 may be controlled by the controller 700.

The controller 700 may control the motor 520 on the basis of a detection result from the detection part 600. For example, when the contraction signal is inputted to the controller 700, the controller 700 may control the drive part 500 (e.g., the motor 520) so that the wheel 210 becomes close to one region of the body part 100.

In addition, when the expansion signal is inputted to the controller 700, the controller 700 may control the drive part 500 (e.g., the motor 520) so that the wheel 210 becomes distant from one region of the body part 100.

In addition, when the contraction signal or expansion signal is inputted to the controller 700, the controller 700 may control the drive part 500 (e.g., the motor 520) so that all of the plurality of variable frames 300 are moved at the same speed.

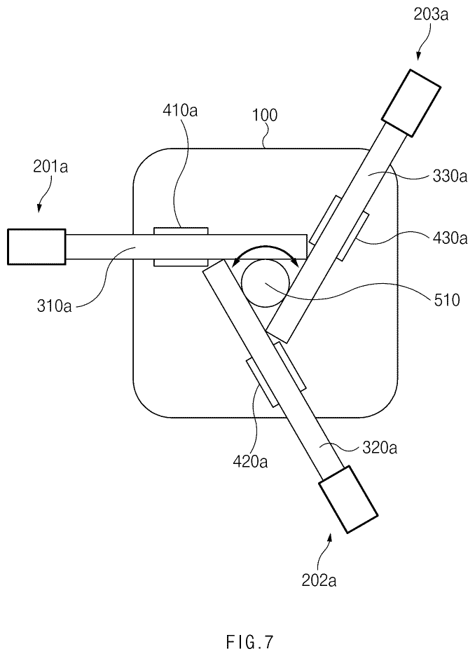

Hereinafter, a mobility vehicle 1 according to a second embodiment of the present disclosure will be described with reference to FIG. 7. The description of the mobility vehicle 1 according to the second embodiment will be focused on a difference between the first and second embodiments.

FIG. 7 is a top plan view of the mobility vehicle according to the second embodiment of the present disclosure.

With reference to FIG. 7, the mobility vehicle according to the second embodiment of the present disclosure may include a body part (100), movement parts (201a, 202a, and 203a), variable frames (310a, 320a, and 330a), guide parts (410a, 420a, and 430a), a drive part, a detection part, and a controller.

The description of the body part 100, the drive part, the detection part, and the controller according to the second embodiment of the present disclosure may be replaced with the description of the body part 100, the drive part 500, the detection part 600, and the controller 700 according to the first embodiment of the present disclosure.

The movement parts 201a, 202a, and 203a may be provided as a plurality of movement parts 201a, 202a, and 203a. The plurality of movement parts 201a, 202a, and 203a may include a first movement part 201a, a second movement part 202a, and a third movement part 203a. For example, the plurality of movement parts 201a, 202a, and 203a may be provided as three movement parts 201a, 202a, and 203a.

The variable frames 310a, 320a, and 330a may be provided as a plurality of variable frames 310a, 320a, and 330a. The plurality of variable frames 310a, 320a, and 330a may include a first variable frame 310a, a second variable frame 320a, and a third variable frame 330a. For example, the plurality of variable frames 310a, 320a, and 330a may be provided as three variable frames 310a, 320a, and 330a.

The first variable frame 310a, the second variable frame 320a, and the third variable frame 330a may have a rotationally symmetrical shape with respect to the rotation region 510 when the upper portion of the mobility vehicle 1 is viewed in parallel with the upward/downward direction H.

An imaginary straight line extending in a direction in which the first variable frame 310a extends may be referred to as a first straight line, an imaginary straight line extending in a direction in which the second variable frame 320a extends may be referred to as a second straight line, and an imaginary straight line extending in a direction in which the third variable frame 330a extends may be referred to as a third straight line. For example, an acute angle among angles defined between two different straight lines among the first straight line, the second straight line, and the third straight line may be 60 degrees.

The first variable frame 310a, the second variable frame 320a, and the third variable frame 330a may be configured to move at the same speed. For example, the first variable frame 310a, the second variable frame 320a, and the third variable frame 330a may each be configured to rectilinearly move at the same speed when the rotation region 510 rotates.

The first variable frame 310a, the second variable frame 320a, and the third variable frame 330a may be disposed to be spaced apart from one another in the upward/downward direction H. In other words, the first variable frame 310a, the second variable frame 320a, and the third variable frame 330a may be disposed such that any one variable frame may move without interfering with another variable frame.

The guide parts 410a, 420a, and 430a may be provided as a plurality of guide parts 410a, 420a, and 430a. The plurality of guide parts 410a, 420a, and 430a may include a first guide 410a, a second guide 420a, and a third guide 430a. The first guide 410a may guide the movement of the first variable frame 310a in the direction in which the first straight line extends. The second guide 420a may guide the movement of the second variable frame 320a in the direction in which the second straight line extends. The third guide 430a may guide the movement of the third variable frame 330a in the direction in which the third straight line extends.

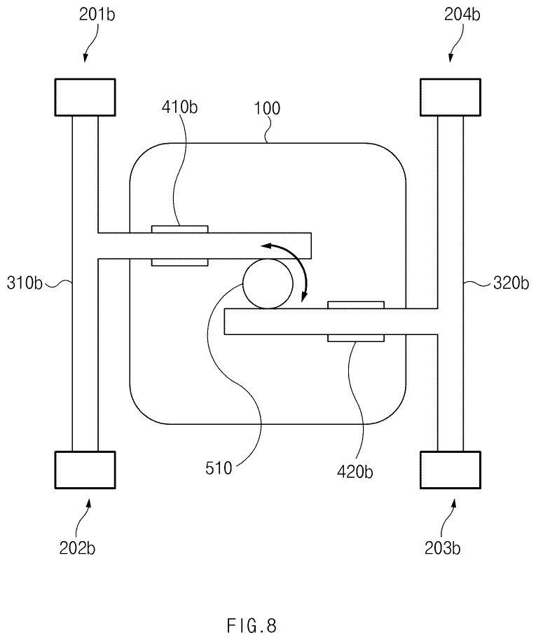

Hereinafter, a mobility vehicle according to a third embodiment of the present disclosure will be described with reference to FIG. 8. The description of the mobility vehicle according to the third embodiment will be focused on a difference between the third embodiment and the first and second embodiments.

FIG. 8 is a top plan view of the mobility vehicle according to the third embodiment of the present disclosure.

With reference to FIG. 8, the mobility vehicle according to the third embodiment of the present disclosure may include a body part (100), movement parts (201b, 202b, 203b, and 204b), variable frames (310b and 320b), guide parts (410b and 420b), a drive part, a detection part, and a controller.

The description of the body part 100, the drive part, the detection part, and the controller according to the third embodiment of the present disclosure may be replaced with the description of the body part 100, the drive part 500, the detection part 600, and the controller 700 according to the first embodiment of the present disclosure.

The movement parts 201b, 202b, 203b, and 204b may be provided as a plurality of movement parts 201b, 202b, 203b, and 204b. The plurality of movement parts 201b, 202b, 203b, and 204b may include a first movement part 201b, a second movement part 202b, a third movement part 203b, and a fourth movement part 204b. For example, the plurality of movement parts 201b, 202b, 203b, and 204b may be provided as four movement parts 201b, 202b, 203b, and 204b.

The variable frames 310b and 320b may each include a first region and a second region. The first region may extend in the guide direction. The first regions may be slidably connected to the guide parts 410b and 420b. The first region may be configured to engage with the rotation region 510.

The second region may extend from one end of the first region in a direction intersecting the guide direction. For example, the first region may have a shape protruding from a central portion of the second region in the guide direction.

The variable frames 310b and 320b may be provided as a plurality of variable frames 310b and 320b. The plurality of variable frames 310b and 320b may include a first variable frame 310b and a second variable frame 320b.

The first region of the first variable frame 310b and the first region of the second variable frame 320b may be disposed to be spaced apart from each other in the direction intersecting the guide direction with the rotation region 510 interposed therebetween. For example, the first region of the first variable frame 310b and the first region of the second variable frame 320b may be disposed to face each other in the direction intersecting the guide direction. In addition, for example, the first region of the first variable frame 310b and the first region of the second variable frame 320b may be oriented in parallel with each other.

The first movement part 201b and the second movement part 202b may be respectively fixed to two opposite ends of the second region of the first variable frame 310b. In other words, in the case of the mobility vehicle according to the third embodiment, two movement parts may be fixed to one variable frame. In addition, the third movement part 203b and the fourth movement part 204b may be respectively fixed to two opposite ends of the second region of the second variable frame 320b. In addition, the first variable frame 310b and the second variable frame 320b may determine a width of the mobility vehicle 1 in the guide direction by means of the rotation of the rotation region 510.

The guide parts 410b and 420b may be provided as a plurality of guide parts 410b and 420b. The plurality of guide parts 410b and 420b may include a first guide 410b and a second guide 420b. The first guide 410b may guide the movement of the first variable frame 310b in the guide direction. The second guide 420b may guide the movement of the second variable frame 320b in the guide direction. The first guide 410b and the second guide 420b may be disposed to be spaced apart from each other in the guide direction and the direction intersecting the guide direction, with the rotation region 510 interposed therebetween.

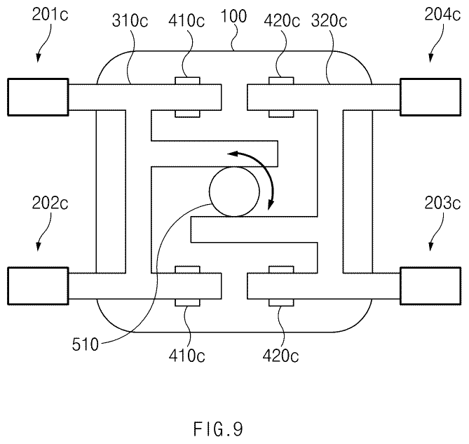

Hereinafter, a mobility vehicle according to a fourth embodiment of the present disclosure will be described with reference to FIG. 9. The description of the mobility vehicle according to the fourth embodiment will be focused on a difference between the fourth embodiment and the first, second, and third embodiments.

FIG. 9 is a top plan view of the mobility vehicle according to the fourth embodiment of the present disclosure.

With reference to FIG. 9, the mobility vehicle according to the fourth embodiment of the present disclosure may include a body part (100), movement parts (201c, 202c, 203c, and 204c), variable frames (310c and 320c), guide parts (410c and 420c), a drive part, a detection part, and a controller.

The description of the body part 100, the drive part, the detection part, and the controller according to the fourth embodiment of the present disclosure may be replaced with the description of the body part 100, the drive part 500, the detection part 600, and the controller 700 according to the first embodiment of the present disclosure.

The movement parts 201c, 202c, 203c, and 204c may be provided as a plurality of movement parts 201c, 202c, 203c, and 204c. The plurality of movement parts 201c, 202c, 203c, and 204c may include a first movement part 201c, a second movement part 202c, a third movement part 203c, and a fourth movement part 204c. For example, the plurality of movement parts 201c, 202c, 203c, and 204c may be provided as four movement parts 201c, 202c, 203c, and 204c.

The variable frames 310c and 320c may each include a first region, a second region, and a third region. The first region may extend in the guide direction. The first regions may be slidably connected to the guide parts 410c and 420c. The first regions may be provided as a plurality of first regions spaced apart from one another in the direction intersecting the guide direction.

The second region may extend from one end of the first region in a direction intersecting the guide direction. For example, the plurality of first regions may each have a shape protruding from a peripheral portion of the second region in the guide direction.

The third region may have a shape protruding from a central portion of the second region in the guide direction. The third region may be configured to engage with the rotation region 510. The third region may be disposed between the plurality of first regions based on the direction intersecting the guide direction. In addition, a length of the third region extending in the guide direction may be longer than a length of the first region extending in the guide direction.

The variable frames 310c and 320c may be provided as a plurality of variable frames 310c and 320c. The plurality of variable frames 310c and 320c may include a first variable frame 310c and a second variable frame 320c.

The third region of the first variable frame 310c and the third region of the second variable frame 320c may be disposed to be spaced apart from each other in the direction intersecting the guide direction with the rotation region 510 interposed therebetween. For example, the third region of the first variable frame 310c and the third region of the second variable frame 320c may be disposed to face each other in the direction intersecting the guide direction. In addition, for example, the third region of the first variable frame 310c and the third region of the second variable frame 320c may be oriented in parallel with each other.

The first movement part 201c and the second movement part 202c may be respectively fixed to two opposite ends of the second region of the first variable frame 310c. In other words, in the case of the mobility vehicle according to the fourth embodiment, two movement parts may be fixed to one variable frame. In addition, the third movement part 203c and the fourth movement part 204c may be respectively fixed to two opposite ends of the second region of the second variable frame 320c. In addition, the first variable frame 310c and the second variable frame 320c may determine a width of the mobility vehicle 1 in the guide direction by means of the rotation of the rotation region 510.

The guide parts 410c and 420c may be provided as a plurality of guide parts 410c and 420c. The plurality of guide parts 410c and 420c may include first guides 410c and second guides 420c. The first guides 410c may be provided as a plurality of first guides 410c. The plurality of first guides 410c may be disposed to be spaced apart from one another in the direction intersecting the guide direction. In addition, the plurality of first guides 410c may be disposed so as not to be spaced apart from one another in the guide direction. In other words, the plurality of first guides 410c may overlap one another when the lateral side of the mobility vehicle is viewed in the direction perpendicular to the guide direction and the upward/downward direction H.

The plurality of first guides 410c may guide the movements of the plurality of first regions provided in the first variable frame 310c. In other words, the plurality of first regions provided in the first variable frame 310c may be slidably connected to the plurality of first guides 410c, respectively.

The second guides 420c may be provided as a plurality of second guides 420c. The plurality of second guides 420c may be disposed to be spaced apart from one another in the direction intersecting the guide direction. In addition, the plurality of second guides 420c may be disposed so as not to be spaced apart from one another in the guide direction. In other words, the plurality of second guides 420c may overlap one another when the lateral side of the mobility vehicle is viewed in the direction perpendicular to the guide direction and the upward/downward direction H.

The plurality of second guides 420c may guide the movements of the plurality of second regions provided in the second variable frame 320c. In other words, the plurality of second regions provided in the second variable frame 320c may be slidably connected to the plurality of second guides 420c, respectively.

In addition, each of the plurality of first guides 410c and each of the plurality of second guides 420c may be disposed to face each other in the guide direction. For example, each of the plurality of first guides 410c and each of the plurality of second guides 420c may be disposed to overlap each other when the lateral side of the mobility vehicle is viewed in parallel with the guide direction.

All the constituent elements, which constitute the embodiments of the present disclosure, may be integrally coupled or operate by being combined, but the present disclosure is not necessarily limited to the embodiment. In other words, one or more of the constituent elements may be selectively combined and operated within the object of the present disclosure. In addition, unless explicitly described to the contrary, the words “comprise,” “include,” or “have” and variations such as “comprises,” “comprising,” “includes,” “including,” has,” or “having,” should be understood to imply the inclusion of stated elements but not the exclusion of any other elements. Unless otherwise defined, all terms including technical or scientific terms may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present disclosure.

The above description is simply given for illustratively describing the technical spirit of the present disclosure, and those having ordinary skill in the art to which the present disclosure pertains should appreciate that various changes and modifications are possible without departing from the essential characteristic of the present disclosure. Therefore, the embodiments disclosed in the present disclosure are provided for illustrative purposes only but not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

What is claimed is:

1. A mobility vehicle comprising:
a body part;
a movement part including:
a wheel configured to move the body part, and
a steering region configured to rotate the wheel about a steering rotation axis relative to the body part and steer the wheel; and
at least one variable frame configured to:
connect the body part and the movement part,
move relative to the body part in a guide direction intersecting the steering rotation axis, and
change a spacing distance between one region of the body part and the movement part.

2. The mobility vehicle of claim 1, wherein the movement part is fixed to the at least one variable frame, and the at least one variable frame is connected to the body part and configured to be movable relative to the body part.

3. The mobility vehicle of claim 1, further comprising:
a guide fixed to the body part, extending in the guide direction, and configured to guide a movement of the at least one variable frame in the guide direction.

4. The mobility vehicle of claim 1, wherein the at least one variable frame includes a plurality of variable frames,
wherein each of the plurality of variable frames is configured to be placed in a first state, in which each variable frame is maximally moved in a first guide direction relative to the body part, wherein the first guide direction is a direction in which the wheel moves toward the body in the guide direction, and
wherein two variable frames, which are oriented in directions intersecting each other among the plurality of variable frames placed in the first state, are disposed to overlap each other when one side of the mobility vehicle based on a direction of the steering rotation axis is viewed in parallel with the steering rotation axis.

5. The mobility vehicle of claim 4, wherein the plurality of variable frames comprises a first variable frame and a second variable frame oriented in the directions intersecting each other, and the first variable frame and the second variable frame are disposed to be spaced apart from each other in the direction of the steering rotation axis.

6. The mobility vehicle of claim 5, wherein the first variable frame is provided as a plurality of first variable frames,
wherein the plurality of first variable frames comprises:
a first-first variable frame; and
a first-second variable frame oriented in parallel with the first-first variable frame, and
wherein at least a part of the first-first variable frame and at least a part of the first-second variable frame are disposed to face each other in a direction perpendicular to the direction of the steering rotation axis.

7. The mobility vehicle of claim 1, further comprising:
a drive part configured to move the at least one variable frame,
wherein the drive part comprises a rotation region configured to engage with the at least one variable frame and rotate about a drive rotation axis, and
wherein the at least one variable frame is configured to be rectilinearly moved in the guide direction by a rotation of the rotation region.

8. The mobility vehicle of claim 7, wherein the at least one variable frame is provided in the form of a rack gear extending in the guide direction, and the rotation region is provided in the form of a pinion gear engaging with the at least one variable frame.

9. The mobility vehicle of claim 1, wherein the steering rotation axis extends in an upward/downward direction, and a lower end of the body part is disposed above an upper end of the wheel.

10. The mobility vehicle of claim 1, further comprising:
a controller configured to control the movement part,
wherein when an adjustment signal, which is a signal indicating that a size of the mobility vehicle is required to be adjusted, is inputted, the controller is configured to control the steering region to steer the wheel in parallel with the guide direction.

11. The mobility vehicle of claim 10, wherein when a contraction signal, which is a signal indicating that a size of the mobility vehicle is required to be decreased, is inputted, the controller is configured to control the wheel so that the wheel becomes close to one region of the body part, and
wherein when an expansion signal, which is a signal indicating that a size of the mobility vehicle is required to be increased, is inputted, the controller is configured to control the wheel so that the wheel becomes distant from one region of the body part.

12. The mobility vehicle of claim 11, wherein the wheel and the at least one variable frame are respectively provided as a plurality of wheels and a plurality of variable frames, and
wherein when the contraction signal or the expansion signal is inputted, the controller is configured to control the plurality of wheels so that all of the plurality of variable frames are moved at the same speed.

13. The mobility vehicle of claim 10, further comprising:
a drive part configured to move the at least one variable frame,
wherein when a contraction signal, which is a signal indicating that a size of the mobility vehicle is required to be decreased, is inputted, the controller is configured to control the drive part so that the wheel becomes close to one region of the body part, and
wherein when an expansion signal, which is a signal indicating that a size of the mobility vehicle is required to be increased, is inputted, the controller is configured to control the drive part so that the wheel becomes distant from one region of the body part.

14. The mobility vehicle of claim 13, wherein the at least one variable frame is provided as a plurality of variable frames, and
wherein when the contraction signal or the expansion signal is inputted, the controller is configured to control the drive part so that all of the plurality of variable frames are moved at the same speed.

15. The mobility vehicle of claim 10, further comprising:
a detection part configured to detect a motion of an object in a peripheral region of the mobility vehicle,
wherein the wheel and the at least one variable frame are respectively provided as a plurality of wheels and a plurality of variable frames,
wherein when the detection part detects a motion of the object in the peripheral region, the controller is configured to receive an avoidance signal, which is a signal indicating that the mobility vehicle is required to avoid the object, from the detection part, and
wherein when among the plurality of wheels, a wheel, which is positioned to be closest to the object, is a short-distance wheel, and a wheel, which is positioned to be farthest from the short-distance wheel, is a long-distance wheel, the controller, which receives the avoidance signal, is configured to control the movement parts so that a speed of the short-distance wheel is higher than a speed of the long-distance wheel.

16. The mobility vehicle of claim 15, wherein the controller, which receives the avoidance signal, is configured to control the movement part to brake the long-distance wheel.

17. The mobility vehicle of claim 15, wherein the controller, which receives the avoidance signal, is configured to control the steering region so that the long-distance wheel is oriented in a direction intersecting the short-distance wheel.

18. The mobility vehicle of claim 15, wherein the plurality of wheels comprises a first wheel, a second wheel, and a third wheel sequentially disposed to be spaced apart from one another in a peripheral direction of the body part, and
wherein when the short-distance wheel and the long-distance wheel are respectively the first wheel and the third wheel, the controller is configured to control the plurality of wheels so that a speed of the first wheel is higher than a speed of the second wheel.
